(19) United States
(12) Patent Application Publication
(10) Pub. No.: US 2019/0058536 A1
(43) Pub. Date: Feb. 21, 2019

(54) UTILIZATION OF LOCATION INFORMATION FOR IMPROVING TRUST MODEL FOR REAL TIME TRAFFIC AND TUNER FUNCTIONS

(71) Applicant: Panasonic Automotive Systems Company of America, Division of Panasonic Corporation of North America, PEACHTREE CITY, GA (US)

(72) Inventors: RAVIKUMAR RAMAN, PEACHTREE CITY, GA (US); PETRU SARCA, PEACHTREE CITY, GA (US); DONALD THOMAS, SMYRNA, GA (US); SHREE JAISIMHA, SENOIA, GA (US)

(21) Appl. No.: 16/103,188

(22) Filed: Aug. 14, 2018

Related U.S. Application Data
(60) Provisional application No. 62/548,227, filed on Aug. 21, 2017.

(51) Int. Cl. H04H 20/55; H04H 40/27; H04B 17/27; H04B 17/318; H04B 1/08; H04K 3/00; G08G 1/09

(52) U.S. Cl. CPC H04H 20/55; H04H 40/27; H04B 17/27; G08G 1/094; H04B 1/082; H04K 3/86; H04B 17/318

(57) ABSTRACT

A method of validating a signal received by a radio from a radio station includes determining a strength of the signal as received by the radio, ascertaining a frequency of the signal, and calculating a first distance between the radio and the radio station dependent upon the strength of the signal as received by the radio. A location and a broadcast range of the radio station are found in a database based on the frequency of the signal, A second distance between the radio and the radio station is computed based on a known location of the radio and the location of the radio station as found in the database. The radio station is validated only if the first distance and the second distance are within a margin of error and if the second distance is within the broadcast range of the radio station.

### CROSS-REFERENCE TO RELATED APPLICATION

This application claims benefit of U.S. Provisional Application No. 62/548,227 filed on Aug. 21, 2017, which the disclosure of which is hereby incorporated by reference in its entirety for all purposes.

### FIELD OF THE INVENTION

The disclosure relates to an infotainment system in a motor vehicle.

### BACKGROUND OF THE INVENTION

A car radio infotainment system serves many end user needs. First, the system entertains the end user with AM or FM station lists. Second, traffic congestion is a problem that is prevalent in many towns and cities. The car radio informs the navigation system of real time traffic data sent through the broadcast medium and thus aids the navigation system in planning a route. This information enables the navigation engine to trigger detours and provide alternative routes as options to the end user. The existing state of the art enables car radios to receive traffic information from broadcasters through the FM band using radio data system (RDS) traffic message channel (TMC). The current problem faced is the trust model for the car receiver to validate that the information it gets from the transmitter is from a valid source in the FM broadcast band.

Broadcasters are embracing different media to broadcast their content. FIG. 1 illustrates the current state of art of the media and their interplay. Data services such as traffic are transmitted in multi-media to reach the end customer in the automotive market. In the current situation, though, there is no proper means for the radio head unit to validate the broadcaster.

The current state of the art makes way for a breach of security whereby a hacker can utilize a software-defined low power transmitter to send wrong information to a car receiver in an unused frequency in the vicinity of the car. Hackers can influence the radio head unit to switch to the frequency by causing interference to the legitimate station and cause the radio to switch to a “perceived” alternate frequency by faking the station identification and validation of the “pirate” frequency.

In case of the RDS traffic message channel (TMC) protocol for example, there is the concept of free traffic and paid traffic. The protocol utilizes the FM band and the RDS Protocol to transmit traffic related data in the form of Group 3A and Group 8 packets. The free traffic, per its name, is free to the end user. The paid traffic requires a cipher lock to decrypt the data. Both means, however, do not allow for proper validation of the source before a receiver can utilize the data. Radio frequency (RF) data sniffers enable hackers to easily record the transmission and correlate the data transmitted to reengineer the encryption.

All of the above-mentioned scenarios allow for hackers to use a low power radio transmitter on top of a car (e.g., adjacent to the target user) and/or on top of a building, for example, and modulate the traffic message signal on the carrier frequency with the data to alter the route of the driver. The need to solve the trust model is key due to new data services that will be supported in the FM band that includes weather and station content.

The current state of the art makes way for breach of security whereby a hacker can utilize a software-defined transmitter or a low power transmitter to simulate a “pirate” station, which is not allowed by federal regulatory agencies, and which has broadcast content that is not accurate.

### SUMMARY

The present invention may validate the integrity of the traffic data received by the car receiver through the broadcast channels in the FM band. The invention may also validate and prevent “pirate” AM or FM radio stations from appearing on the user station list for end user selection. Further, the invention may improve AM station list population at dusk and improve end user listenership. The invention may define a means to achieve a trust model for the car receiver to validate that the information that the receiver gets from the transmitter is from a valid source both for the FM and AM stations.

The security threat may be modeled between an information source and a sink involving the following scenarios of interception, interruption, modification and fabrication. Interception may occur when an attacker has access to the communication channel between the source and sink entities.

Interruption may occur when an attacker has a way to interrupt communication between the source and sink. The present invention may apply to this scenario where an attacker can cause the radio head unit software algorithm to switch from a valid traffic provider to an invalid entry by causing interference for the valid station.

Modification may occur when the attacker intercepts the message, changes the content of the message, and resubmits the message back to the sink.

Fabrication may occur when the attacker acts like a source. The present invention may apply to this scenario where an attacker can operate at a frequency not used in the current vicinity of the car, and acts as a valid traffic source provider.

The invention may solve the problem involving validating the integrity of the traffic data broadcast provider received through the broadcast channels to the car receiver.

The invention may also solve the problem involving validating and preventing “pirate” AM or FM radio stations from appearing on the user station list for end user selection.

The invention may further solve the problem involving improving an AM station list population at dusk and thereby improving end user listenership. The invention can improve the performance of an AM station list population during dusk where the modulation from distant transmitters is amplified due to tropospheric reflection. This phenomenon causes the quality of station signals received at dusk and night time to be of poor quality.

The invention may include validating the broadcaster by comparing the actual received signal strength against the estimated signal strength of the currently tuned broadcast station at the receiver utilizing the broadcaster's transmitter power and the broadcaster's geospatial location from a database including valid federal communications commission (FCC) approved stations.

In one embodiment, the invention comprises a method of validating a signal received by a radio from a radio station, including determining a strength of the signal as received by the radio, ascertaining a frequency of the signal, and calculating a first distance between the radio and the radio station dependent upon the strength of the signal as received by the radio. A location and a broadcast range of the radio station are found in a database based on the frequency of the signal. A second distance between the radio and the radio station is computed based on a known location of the radio and the location of the radio station as found in the database. The radio station is validated only if the first distance and the second distance are within a margin of error and if the second distance is within the broadcast range of the radio station.

In another embodiment, the invention comprises a method of validating a signal received by a radio from a radio station, including determining a power level of the signal as received by the radio, ascertaining a frequency of the signal, and finding a location and a transmission power of the radio station in a database based on the frequency of the signal. An expected power level of the signal as received by the radio is estimated dependent upon the transmission power of the radio station and a distance between the radio and the radio station based on a known location of the radio and the location of the radio station as found in the database. The radio station is validated only if a difference between the determined power level of the signal as received by the radio and the expected power level of the signal as received by the radio is less than a threshold value.

In yet another embodiment, the invention comprises a method of validating a signal received by a radio front a radio station, including determining a strength of the signal as received by the radio, ascertaining a frequency of the signal, and calculating a first distance between the radio and the radio station dependent upon the strength of the signal as received by the radio, The radio station is identified by referring to a database based on the frequency of the signal. A location and a broadcast range of the identified radio station are looked up in the database. A second distance between the radio and the radio station is computed based on a known location of the radio and the location of the radio station as found in the database. The radio station is validated only if the first distance and the second distance are within a margin of error and if the second distance is within the broadcast range of the radio station.

### BRIEF DESCRIPTION OF THE DRAWINGS

A better understanding of the present invention will be had upon reference to the following description in conjunction with the accompanying drawings.

FIG. 1 is a block diagram of interplay between example broadcasting media of the prior art.

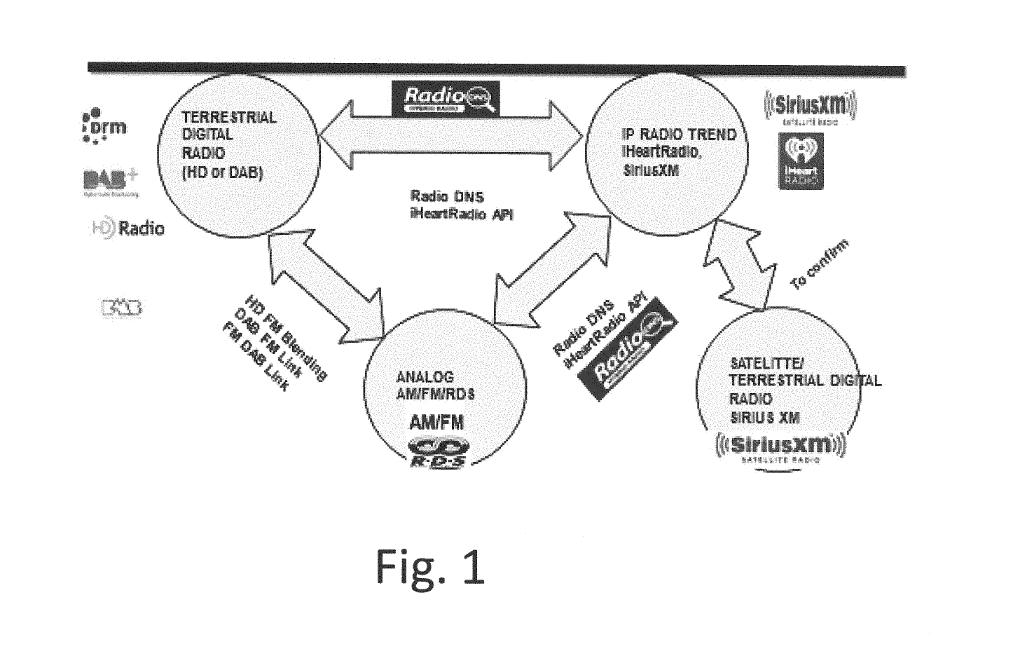

FIG. 2 is an example excerpt of a table from a web-portal for FM stations.

FIG. 3 is a block diagram of a typical front end of a radio.

FIG. 4 is another block diagram of a typical front end of a radio.

FIG. 5 is an example map of the reception range of an FM radio station.

FIG. 6 is an example plot of attenuation of signal power versus control voltage at an AGC.

FIG. 7 is a block diagram showing secure communication using SSL certificates between a radio head unit and a web portal.

FIG. 8 is a block diagram of communication between a client and a server in one embodiment.

FIG. 9 is a flow chart of one embodiment of a method of creating a station list.

FIG. 10 is a diagram of a head unit receiving signals from two legitimate transmitters and one hacker transmitter.

FIG. 11 is a flow chart of one embodiment of a method of the present invention for validating a signal received by a radio from a radio station.

### DETAILED DESCRIPTION OF THE PREFERRED EMBODIMENTS

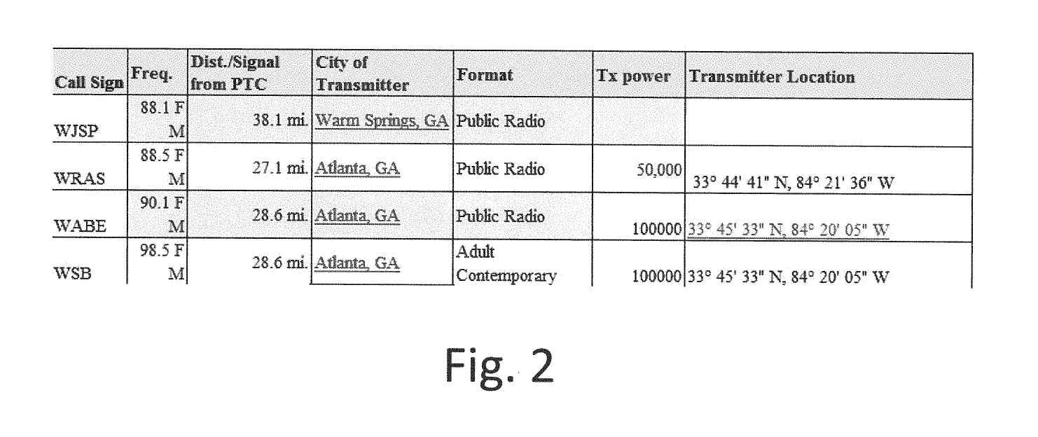

The invention may include validating the broadcaster by comparing the actual received signal strength against the estimated signal strength of the currently tuned broadcast station. This validation may include a three-step process. In a first step, a database of broadcast transmitters, their power and geospatial locations may be utilized. The radio head unit can query a web-portal using an embedded cell modem or a device brought into the vehicle. The radio head unit can also query a fixed database in its non-volatile memory. For example, web-portals such as radio-locator have the relevant data of various radio station transmitters' location, power and frequency for valid AM and FM stations. The table of FIG. 2 is an excerpt from one such above-mentioned portal for FM stations.

The portal may also have information about AM stations. The data in the table may provide P_{T}=transmit power for use in the equation below, as discussed below with reference to the third step of the three-step process:

$${P}_{R} = {P}_{T} {G}_{T} {{G}_{R} [ \frac{λ}{4 π R} ]}^{2}$$

In a second step of the three-step process, the distance R between the receiver and the transmitter is found. The next item in the computation of the distance between the broadcast transmitter and the radio head unit may use the geospatial location of both entities using the haversine formula. For this, the transmitter location from the web-portal may be converted into degrees and seconds for use in the computer algorithm. Once P_{T} is obtained from the database, the haversine formula may be used to compute the value R in the above equation.

The value of P_{R} may actually be:

P_{R estimated}′=estimated power computed using Geospatial location

Example sample code used for calculation of the distance R between the receiver and the transmitter using the implementation of the haversine formula is listed below:

```
#include <math.h>
#include <iostream>
using namespace std;
static const double EarthRadius = 6371000; // meters
static const double Deg2Rad = 3.1415926536 / 180;
// Returns the air distance in meters between the two lat/lon pairs
double distance(double lat1, double lon1, double lat2, double lon2)
{
  double dx, dy, dz;
  lon1 −= lon2;
  lon1 *= Deg2Rad, lat1 *= Deg2Rad, lat2 *= Deg2Rad;
  dz = sin(lat1) − sin(lat2);
  dx = cos(lon1) * cos(lat1) − cos(lat2);
  dy = sin(lon1) * cos(lat1),
  return asin(sgrt(dx * dx + dy * dy + dz * dz / 2) * 2 * EarthRadius;
}
//Example; 50,000 Watts, 88.5 MHz, 14.1 miles away. Geospatial location; 33.744828, −
84.359926 transmitter
// Geospatial location: 33.395873, −84.604403 − PTC
int main( )
{ std::cout << std::fixed << ″PTC to 88.5 MHz FM transmitter: ″ <<
distance(33.395873, −84.604403,33.744828, −84.359926) << ″in meters″ << std::endl;
  return 0;
}
```

This may be done in preparation for the third step of the three-step process wherein received power may be compared to the estimated reception power. In this third step, the received power of the tuned station may be compared to the estimated reception power of the transmitter with respect to the current location.

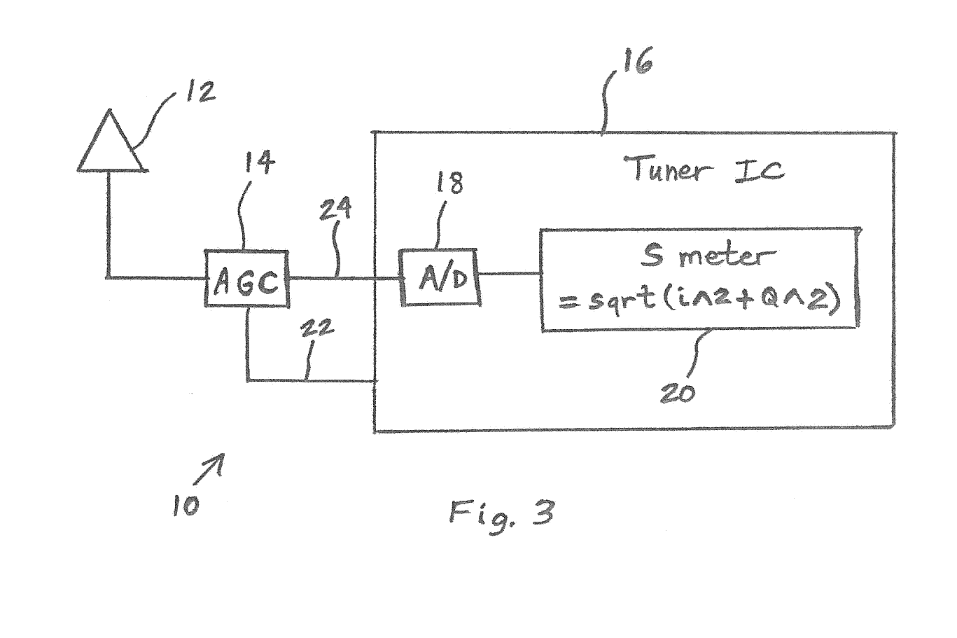

A simplified block diagram of a typical front end 10 of a radio is shown in FIG. 3, including an antenna 12, an automatic gain control (AGC) 14, and a tuner integrated circuit (IC) 16 having an analog-to-digital converter 18 and a signal strength meter 20. The power received at antenna 12 may be referred to as P_{R}. Tuner IC 16 may issue a control voltage V_{c} at 22 for adjusting AGC circuitry 14. The power received at input 24 of tuner IC 16 may be referred to as P_{R}′. Signal strength meter 20 may read and indicate the power level P_{R}′.

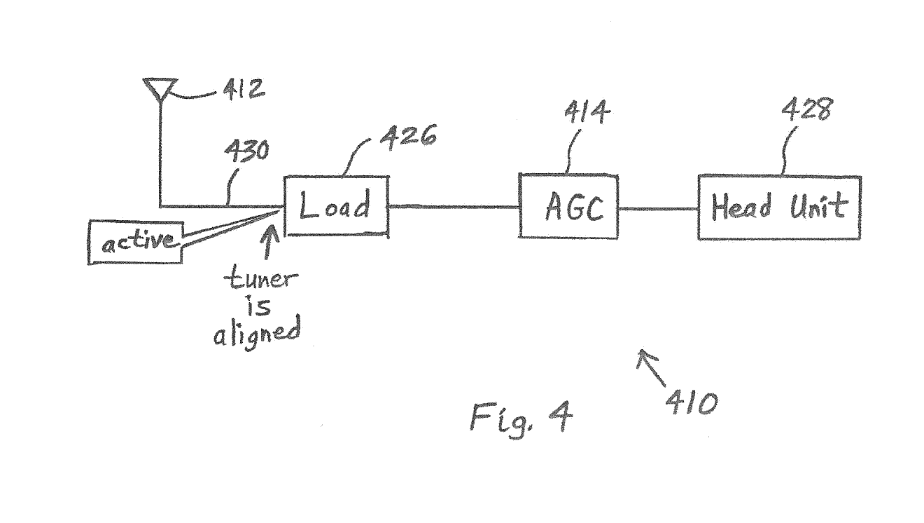

Another simplified block diagram of a typical front end 410 of a radio is shown in FIG. 4, including an antenna 412, a load 426, an automatic gain control (AGC) 414, and a head unit 428. The potential losses that can arise due to impedance mismatches between an active or passive antenna may be accounted for. The software may support tuner level alignment to ensure the S meter reading comes from the point 430 before dummy load 426 and not after. The rationale for this may be to ensure that the algorithm accounts for the received power at the receiver antenna.

The invention may utilize the input power P_{R}′ (wherein P_{R}′=actual power received at the input of the tuner IC) of the tuner IC 16 to aid in the determination of the physical location of the radio in the presence of automated gain control circuitry. The free-space power received (P_{R}) by an antenna, with a gain (G_{R}), separated by a distance (R) from a transmitting power antenna with a power level P_{T} and antenna gain (G_{T}), may be modeled through the use of the Friis equation:

$${P}_{R} = {P}_{T} {G}_{T} {{G}_{R} [ \frac{λ}{4 π R} ]}^{2}$$

Where P_{R}=received power

P_{R}′=actual power received at the input of the tuner IC

P_{R estimated}′=estimated power computed using Geospatial location

P_{T}=transmit power

G_{T}=transmit antenna gain

G_{R}=receive antenna gain

R=distance between transmit and receive antenna

$$λ = \frac{c}{f} = wavelength ,$$

where c=speed of light (3×10⁸ m/s) and f=frequency of operation in Hz

V_{c}=control voltage adjusting Automatic Gain Control (AGC) circuitry

Sₘₑₜₑᵣ=indicator for reading power level of Pᵣ′ by software means

Herein G_{R}=receive antenna gain, which may be dependent upon whether a rod antenna (an active or passive antenna) or an in-glass antenna is being used, where gain of the directivity is also considered part of G_{R}.

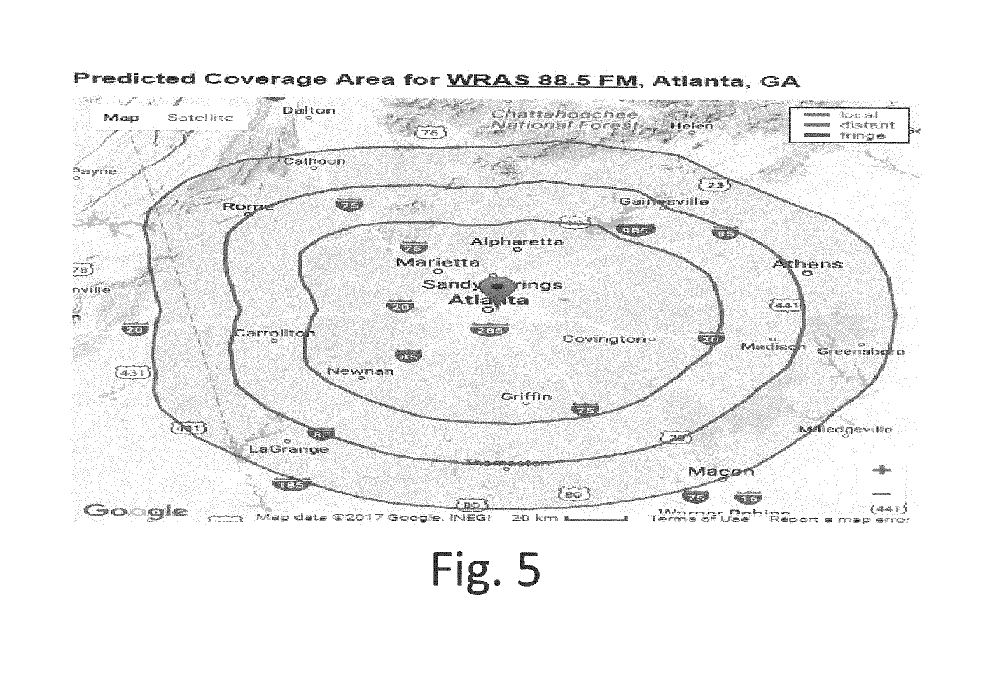

FIG. 5 is an example map of the reception range or coverage of an FM radio station transmitting at 88.5 MHz.

With regard to the role of the AGC, as noted above with reference to FIGS. 3-4, the power received at the radio head-unit (P_{R}′) is not necessarily the same as that received by the antenna (P_{R}). The RF front end of the radio has automated gain control (AGC) circuitry which prevents overloading/saturating the tuner IC. The AGC circuitry increases the attenuation in the RF path in strong signal conditions (e.g., when the receiver is in close proximity to the transmit tower) and decreases the attenuation in weak signal conditions (e.g., when the receiver is farther away from the transmitter). In the weak signal condition, it is assumed that P_{R}=P_{R}′. In the strong signal condition, it is assumed that P_{R}>P_{R}40 .

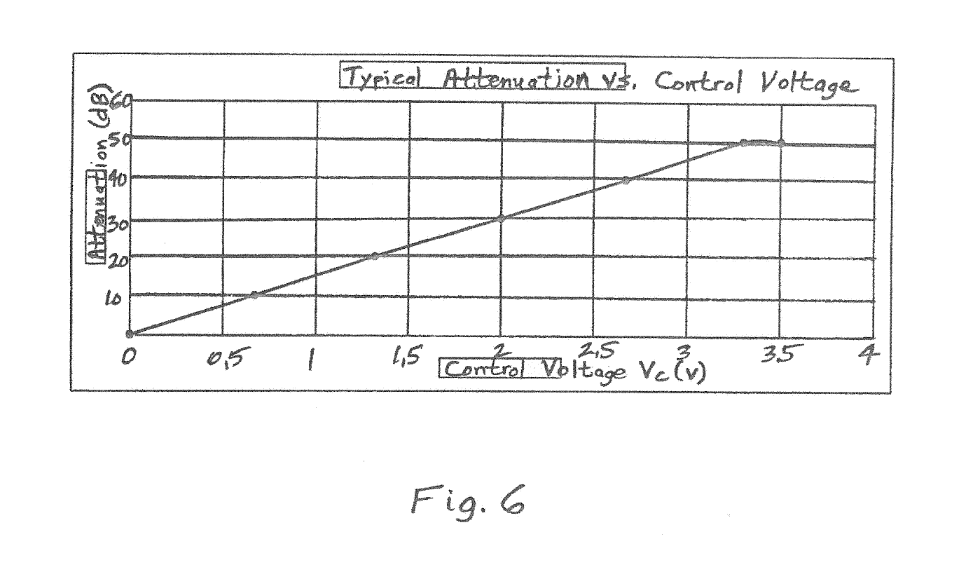

Although the attenuation varies by tuner design, a typical curve of attenuation versus control voltage is shown in FIG. 6, where V_{c} is the control voltage for biasing the AGC circuitry. Therefore, by reading the control voltage (V_{c}) and Sₘₑₜₑᵣ reading (P_{R}′) from the tuner, the attenuation may be interpolated from the AGC table. Accounting for the attenuation enables the power received at the antenna to be determined from:

P_{R}=P′+Attenuation

The attenuation may be measured and kept within the algorithm. The received power is in Watts. However, the tuner IC provides the Smeter reading to the software logic in dBuV (dB microvolt). The translation formulae for this is may be as follows:
P_{R}′ of the received broadcast power is in Watts at the antenna.
1) The Watts to dBm conversion formula: dBm=10 log (P_{R})±30
2) The dBm to dBuV conversion formula: dBuV=90+10 log (Z)+dBm,
where Z is the characteristic impedance which is usually either 50 ohms or 75 ohms depending on the tuner impedance design.

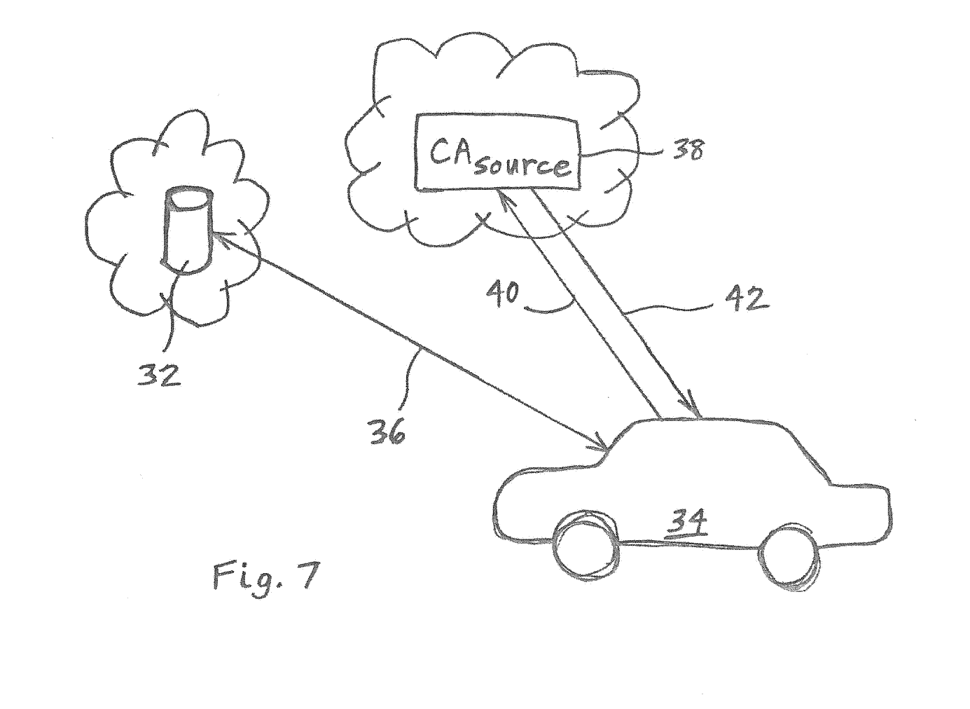

The validity of the station may be confirmed if P_{R}′ (actual power received at the input of the tuner IC) and P_{R estimated}′ (estimated power computed using a geospatial location) is within a certain error margin. As shown in FIG. 7, the car may utilize secure communication using Secure Sockets Layer (SSL) based certificates between the web portal 32 and the radio head unit in vehicle 34. Webportal 32 may transmit a certificate via communications 36 with vehicle 34. Vehicle 34 may then send the certificate to a certificate authentication source 38, as indicated at 40. Source 38 may then transmit certificate authentication to vehicle 34, as indicated at 42.

The car protects for secure communication using libcurl/SSL libraries and can communicate to an offboard content delivery server using HTTP. The server may have an authentication method.

In one embodiment, a trusted station database is maintained in the head unit. However, this may not reflect changes involving broadcaster consolidation.

In another embodiment, a trusted station database is maintained in an offboard server. When a user tunes to a station, there may be a HTTPS request to an external server.

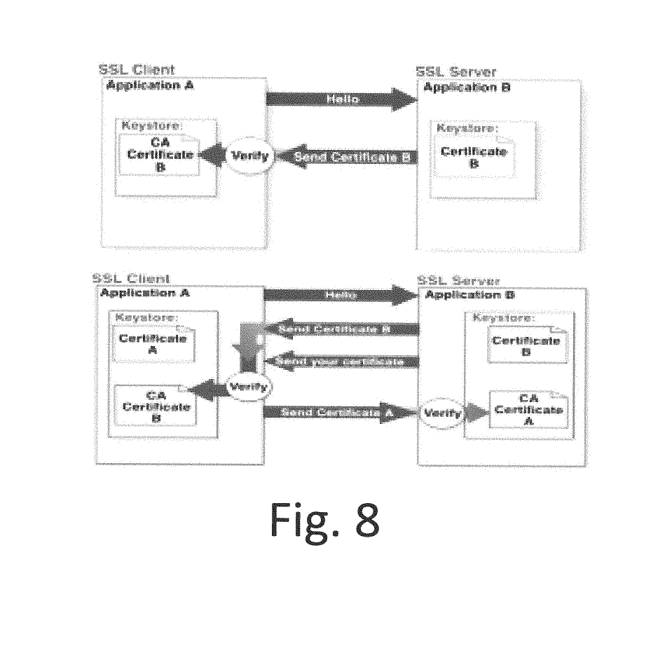

Secure communication between the car and the cloud may be made possible by using either one-way SSL or two-way SSL. The details of the communication between the client and the server in one embodiment are shown in FIG. 8. The car may compute the geospatial distance between itself and the transmitters.

The invention may validate the integrity of the traffic data received through the broadcast channels at the car receiver in the FM band. The invention may also validate and prevent “pirate” AM or FM radio stations from appearing on the user station list for end user selection. Further, the invention may improve AM station list population at dusk and improve end user listenership.

The invention may make use of the transmitter database that has information pertaining to the broadcaster frequency, transmitter power (that can include day or night patterns that apply for the AM band), location of the broadcast transmitter in terms of latitude and longitude, and the polarization of the transmission (horizontal, vertical, circular or mixed) for better power determination accuracy.

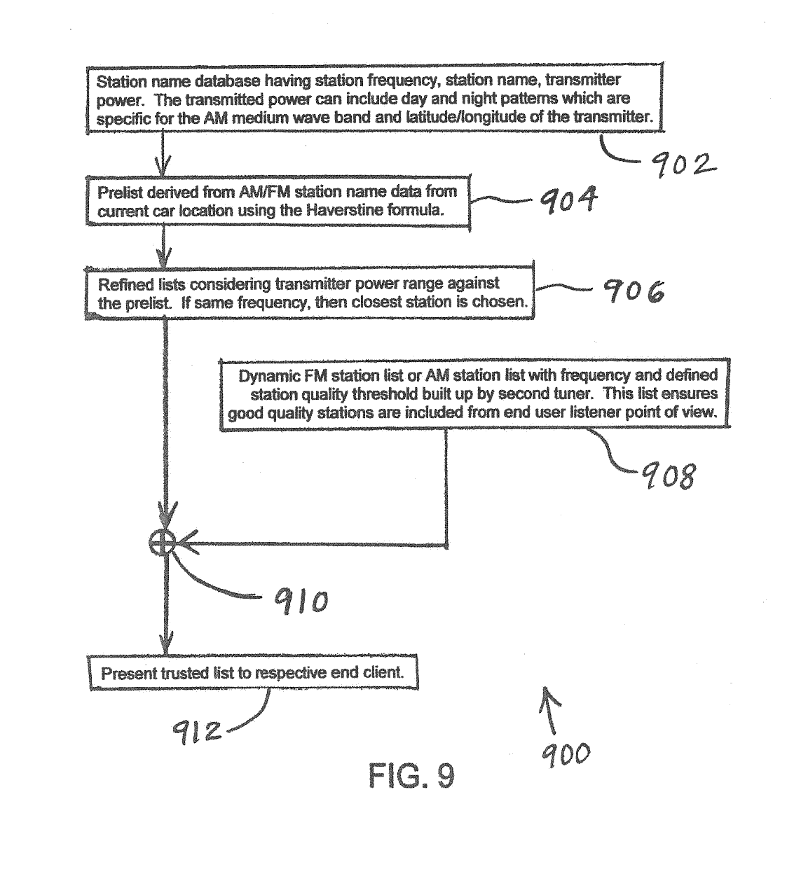

To inhibit “pirate” stations from appearing as a result of user selection, the logic of FIG. 9 may be implemented. FIG. 9 illustrates one embodiment of a method 900 of creating a station list. In a first step 902, a station name database stores station frequencies, station names, and transmitter power. The transmitted power can include day and night patterns, which are specific for the AM medium wave band, and the latitude/longitude of the transmitter. Next, in step 904, a prelist is derived from the AM/FM station name data and from the current car location using the haverstine formula. In a next step 906, a list is refined by considering the transmitter power range of the stations in the prelist. If multiple stations transmit at the same frequency, then the closest station is chosen. In step 908, a dynamic FM station list or an AM station list with frequency and a defined station quality threshold is built up by second tuner. This list ensures that good quality stations are included from the end user listener point of view. Next, in step 910, the results of steps 906 and 908 are combined with AND condition logic. Stations from a dynamic FM station list/AM station list may be compared with stations derived from a static transmitter map, and matching station names may be selected. In a final step 912, a trusted list is presented to a respective end client.

In FIG. 9, on the flow of events in steps 902, 904, 906, valid stations may be derived from the vicinity of the car from the web portal using secure communication. The web portal may have a database of trusted stations in the area.

The Haversine formula may be used to determine the proximity of the car and of the transmitter for a range of valid stations. In the flow of events in step 908, the tuner is able to scan the band and provide a list of stations that meet a certain signal quality threshold.

At step 910, an AND condition may be performed between the trusted list and the stations perceived by the background scan operation of the tuners on the radio head unit to provide the valid station list to the end user in step 912.

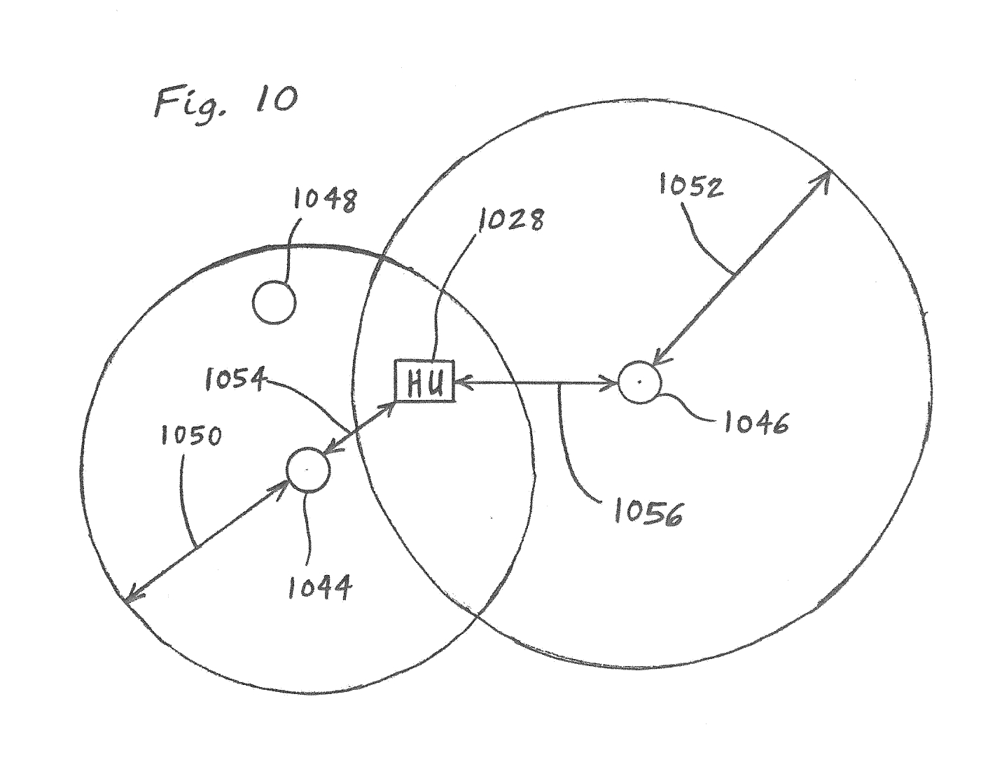

FIG. 10 is a diagram of a head unit 1028 receiving signals from two legitimate transmitters 1044, 1046 and one hacker transmitter 1048. A database of legitimate transmitters may be received by head unit 1028 through an embedded cell modem and/or internal database.

Transmitter power spans or broadcast ranges 1050, 1052 of transmitters 1044, 1046, respectively, may be calculated by radio head unit 1028 in terms of distance and based on the power of the particular transmitter. The system may calculate distances 1054, 1056 between radio head unit 1028 and broadcast transmitters 1044, 1046, respectively, by use of the Haversine formula.

In order for the station frequency to be considered a valid entry, the distance between the broadcasting transmitter and the radio head unit has to be less than the distance of the power span or broadcasting range of the broadcasting transmitter, as provided by the database. The system may then employ an AND condition with the distance provided by the database and stations noted by the background scan operation of the second tuner to confirm its legitimacy. Hacker transmitter 1048 may be perceived by the second tuner as part of background scan, but may not be considered a valid station because it is not listed in the database.

The radio head unit may get the legitimate transmitter database from the cloud or may use an onboard list. The head unit may then compute the distance between itself and all the legitimate broadcast transmitters in the database.

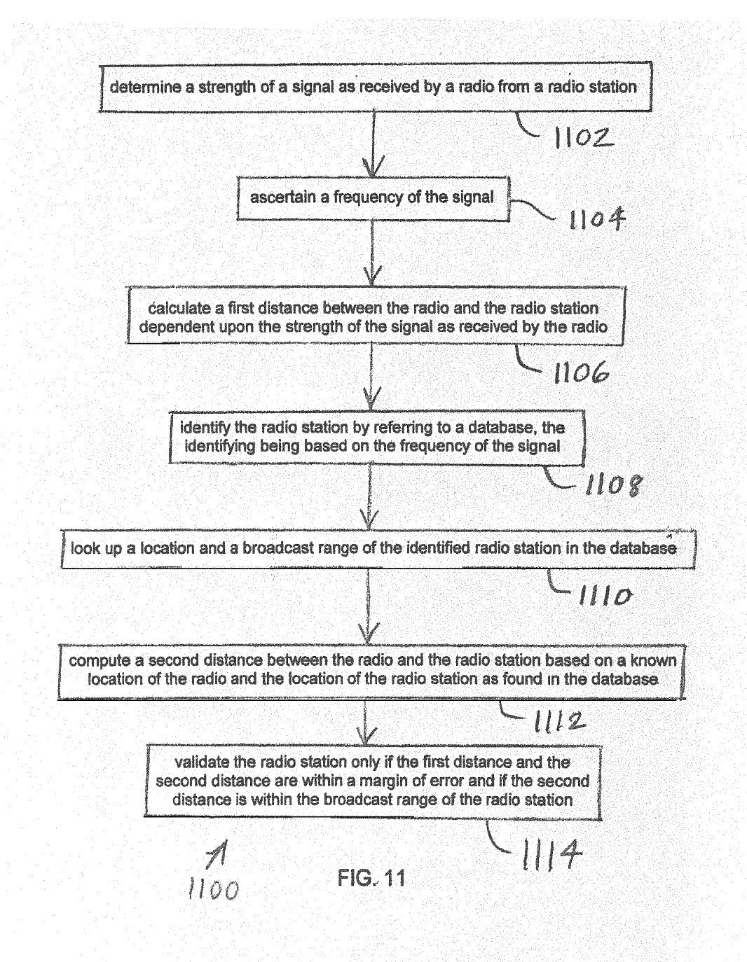

FIG. 11 illustrates one embodiment of a method 1100 of the present invention for validating a signal received by a radio from a radio station. In a first step 1102, a strength of the signal as received by the radio is determined. For example, signal strength meter 20 may measure the strength of a signal received by a front end 10 of a radio.

Next, in step 1104, a frequency of the signal is ascertained. For example, a radio head unit can query a web-portal using an embedded cell modem or a device brought into the vehicle. The web-portal may provide the frequency of various radio station transmitters.

In a next step 1106, a first distance between the radio and the radio station is calculated dependent upon the strength of the signal as received by the radio. For example, distances 1054, 1056 between radio head unit 1028 and broadcast transmitters 1044, 1046, respectively, may be calculated by use of the Haversine formula.

In step 1108, the radio station is identified by referring to a database. The identifying is based on the frequency of the signal. For example, a station name database may store station frequencies, station names, and transmitter power. The name or other identity of the station may be found in the database by looking up the station's frequency.

Next, in step 1110, a location and a broadcast range of the identified radio station are looked up in the database. That is, the location and broadcast range of each station may also be stored in the database, and thus may be looked up in the database in association with the identity of the station.

In a next step 1112, a second distance between the radio and the radio station is computed based on a known location of the radio and the location of the radio station as found in the database. For example, the location of the radio may be determined via a GPS module, and a distance from the radio location to the location of the station found in the database may be calculated.

in a final step 1114, the radio station is validated only if the first distance and the second distance are within a margin of error and if the second distance is within the broadcast range of the radio station. For example, the difference between the first distance and the second distance may be no more than ten percent in one embodiment, and the second distance must be less than the broadcast range of the radio station as found in the database. If these conditions are met, then the radio station may be validated.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A method of validating a signal received by a radio from a radio station, the method comprising:
determining a strength of the signal as received by the radio;
ascertaining a frequency of the signal;
calculating a first distance between the radio and the radio station dependent upon the strength of the signal as received by the radio;
finding a location and a broadcast range of the radio station in a database based on the frequency of the signal;
computing a second distance between the radio and the radio station based on a known location of the radio and the location of the radio station as found in the database; and
validating the radio station only if the first distance and the second distance are within a margin of error and if the second distance is within the broadcast range of the radio station.

2. The method of claim 1 further comprising including the radio station on a list of preset radio stations only after the radio station has been validated.

3. The method of claim 1 wherein the signal is received by a first tuner of the radio, and the radio station is validated only if the radio station is noted during a background scan performed by a second tuner of the radio.

4. The method of claim 1 wherein the first distance between the radio and the radio station is calculated by use of the Haverstine formula.

5. The method of claim 1 wherein the radio communicates with the database via a cell modem.

6. The method of claim 1 wherein the database is stored in a motor vehicle that includes the radio.

7. The method of claim 1 wherein the step of finding a broadcast range of the radio station in the database is dependent upon a time of day.

8. A method of validating a signal received by a radio from a radio station, the method comprising:
determining a power level of the signal as received by the radio;
ascertaining a frequency of the signal;
finding a location and a transmission power of the radio station in a database based on the frequency of the signal;
estimating an expected power level of the signal as received by the radio, the estimating being based upon the transmission power of the radio station and a distance between the radio and the radio station based on a known location of the radio and the location of the radio station as found in the database; and
validating the radio station only if a difference between the determined power level of the signal as received by the radio and the expected power level of the signal as received by the radio is less than a threshold value.

9. The method of claim 8 further comprising including the radio station on a list of preset radio stations only after the radio station has been validated.

10. The method of claim 8 wherein the signal is received by a first tuner of the radio, and the radio station is validated only if the radio station is noted during a background scan performed by a second tuner of the radio.

11. The method of claim 8 wherein the expected power level of the signal as received by the radio is estimated by use of the Haverstine formula.

12. The method of claim 8 wherein the radio communicates with the database via a cell modem.

13. The method of claim 8 wherein the database is stored in a motor vehicle that includes the radio.

14. A method of validating a signal received by a radio from a radio station, the method comprising:
determining a strength of the signal as received by the radio;
ascertaining a frequency of the signal;
calculating a first distance between the radio and the radio station dependent upon the strength of the signal as received by the radio;
identifying the radio station by referring to a database, the identifying being based on the frequency of the signal
looking up a location and a broadcast range of the identified radio station in the database;
computing a second distance between the radio and the radio station based on a known location of the radio and the location of the radio station as found in the database; and
validating the radio station only if the first distance and the second distance are within a margin of error and if the second distance is within the broadcast range of the radio station.

15. The method of claim 14 further comprising including the radio station on a list of preset radio stations only after the radio station has been validated.

16. The method of claim 14 wherein the signal is received by a first tuner of the radio, and the radio station is validated only if the radio station is noted during a background scan performed by a second tuner of the radio.

17. The method of claim 14 wherein the first distance between the radio and the radio station is calculated by use of the Haverstine formula.

18. The method of claim 14 wherein the radio communicates with the database via a cell modem.

19. The method of claim 14 wherein the database is stored in a motor vehicle that includes the radio.

20. The method of claim 14 wherein the step of looking up a broadcast range of the radio station in the database is dependent upon a time of day.
